(19) United States
(12) Patent Application Publication
(10) Pub. No.: US 2012/0322323 A1
(43) Pub. Date: Dec. 20, 2012

(54) ELECTRICAL CONNECTION MEANS

(75) Inventor: James Fowler, Ilkley (GB)

(73) Assignee: Optilume Ltd.

(21) Appl. No.: 13/524,840

(22) Filed: Jun. 15, 2012

(30) Foreign Application Priority Data
Jun. 15, 2011 (GB) 1110019.5

(51) Int. Cl. H01R 13/02

(52) U.S. Cl. 439/884

(57) ABSTRACT

Electrical connection means are provided for a first item for allowing electrical connection between the first item or a part of the first item with electrical means of at least a second item or further part of the first item. The electrical connection means include first and at least second non-linear surfaces or parts providing one or more electrical terminals for the electrical connection means.

This invention relates to electrical connection means and a method of use thereof.

Although the following description refers almost exclusively to electrical connection means associated with a battery for allowing electrical connection with a battery recharger, it will be appreciated by persons skilled in the art that the electrical connection means of the present invention can be used to allow electrical connection between any two or more items or parts of items.

A conventional battery typically comprises an electrochemical cell contained within a housing having a positive terminal and a negative terminal, for connection to a positive terminal and a negative terminal respectively, of an item that the battery is to be charged by or, that the battery is to power. The positive and negative terminals of both the battery and the item are typically flat or linear surfaces that abut against each other to form an electrical contact. A problem associated with conventional batteries and battery chargers is that the electrical terminals of each have to be aligned and orientated in a pre-determined manner in order to ensure the flat terminal surfaces are able to make electrical contact with each other. This can be time consuming and fiddly for a user to achieve.

A further example of a conventional electrical connection between a battery and a battery charger includes a pin or blade provided on one of the battery or battery charger that fits into a substantially U-shaped channel provided on the other of the battery or battery charger. A problem with this arrangement is that dirt can collect in the U-shaped channel over time and the electrical connection is difficult to clean.

It is therefore an aim of the present invention to provide electrical means and/or electrical connection means that overcome the abovementioned problems.

It is a further aim of the present invention to provide a method of using electrical means and/or electrical connection means that overcomes the abovementioned problems

It is a yet further aim of the present invention to provide electrical connection apparatus including electrical connection means provided on or associated with a first item or part and electrical means provided on or associated with a second item of further first item part.

It is a further aim of the present invention to provide a method of using electrical connection apparatus.

According to a first aspect of the present invention there is provided electrical connection means for a first item for allowing electrical connection between the first item or a part of the first item with electrical means of at least a second item or further part of the first item in use, said electrical connection means including first and at least second non-linear surfaces or parts providing one or more electrical terminals for the electrical connection means.

By providing one or more electrical terminals in the form of or including non-linear surfaces (i.e. surfaces that are not flat), this allows the electrical connection means, typically provided on or associated with the first item or part, to be brought into engagement with the electrical means associated with the at least second item or further first item part in any orientation. In addition, in the case where the first item on which the electrical connection means is provided is a battery, the non-linear surfaces of the electrical connection means ensures the battery is not short circuited by contact with a flat terminal surface of a second item.

Preferably the non-linear surfaces include at least the electrically conductive part of the electrical terminals and/or electrical connection means.

Preferably the first and at least second non-linear surfaces or parts are formed from electrically conductive material.

In one embodiment the first non-linear surface or part acts as a first electrical terminal and the second non-linear surface or part acts as a second electrical terminal. In an alternative embodiment the first and second non-linear surfaces both act as a first or positive terminal, or they act as a second or negative terminal.

Preferably insulation means, such as electrical insulation means, non-conductive means or means having poor or non electrical conductivity, are provided between, and further preferably adjacent to, said first and at least second non-linear surfaces to insulate the electrical terminals from each other.

The insulation means can include any or any combination of an insulating material, a gap, a space, pre-determined spaced distance, substantially non-electrically conductive material and/or the like.

Preferably the electrical terminals are in the form of at least one positive electrical terminal and at least one negative electrical terminal.

Preferably the first and/or at least second non-linear surfaces are formed from electrically conductive material, such as metal, a metal alloy and/or the like.

The non-linear surfaces can include any or any combination of one or more substantially dome shapes, curved surfaces, partially or wholly spherical surfaces, concave surface, convex surface, an arc of a circle, one or more substantially annular members and/or the like.

In one embodiment one of the first and at least second non-linear surfaces is substantially dome shaped and the other of the first and at least second non-linear surfaces is substantially annular in shape or form.

Preferably the substantially dome shaped surface and the substantially annular surface are substantially concentrically arranged.

Preferably the substantially annular member has a larger diameter than the diameter of the substantially dome shaped member.

In one embodiment the substantially dome shaped surface provides the positive electrical terminal and the substantially annular member provides the negative electrical terminal for the electrical connection means.

Preferably the substantially dome shaped surface and/or positive electrical terminal is associated with or provided at a free end of the electrical connection means.

In one embodiment the electrical connection means is in the form of a blade, arm member or pin. Preferably an electrical terminal, the substantially dome shaped surface and/or positive electrical terminal is associated with or provided at a free end of the blade, arm member or pin.

Preferably the at least one substantially annular member and/or negative electrical terminal is associated with or provided a spaced distance apart from a free end of the electrical connection means. Further preferably the at least one substantially annular member, electrical terminal and/or negative electrical terminal is provided on a blade, arm member or pin and a spaced distance apart from a free end thereof.

Preferably the electrical insulation means or non-conductive material includes or is in the form of one or more non-linear surfaces. The electrical insulation means or non-conductive material can be in the form of any or any combination of one or more substantially dome shapes, curved surfaces, partially or wholly spherical surfaces, concave or convex surfaces, and arc of a circle, one or more substantially annular members and/or the like.

In a preferred embodiment the electrical insulation member or non-conductive material is a substantially annular member. Preferably the substantially annular insulation or non-conductive member, the at least one annular terminal member and/or the dome shaped surface arc substantially concentrically arranged.

In a preferred embodiment the free end of the electrical connection means is substantially dome shaped and provides the first non-linear surface, an annular member is provided a spaced distance apart from the first non-linear surface to form the at least second non-linear surface and an electrical insulation or non-conductive member in the form of a further annular member is provided between the first and second non-linear surfaces.

Preferably the electrical insulation or non-conductive member is adjacent to and/or in abutting relationship with a surface of the first non-linear terminal surface and a surface of the second non-linear terminal surface.

In one aspect of the present invention electrical means provided on or associated with the second item or further first item part in use includes magnetic means, magnetic material and/or one or more magnets.

Preferably the magnetic means, magnetic material and/or one or more magnets are magnetically attracted to at least one of the electrical terminals of the electrical connection means associated with the at least first item or part to improve engagement between the electrical means and electrical connection means of the second and first items or parts in use.

Preferably the polarity of the magnetic means is opposite to the polarity of at least one of the electrical terminals of the electrical connection means associated with the at least first item or part to which it engages with in use so as to be magnetically attracted thereto.

Preferably at least part of the magnetic means provides an electrical terminal for the electrical means of the at least second item or further first item part. Further preferably the magnetic means is the same positive or negative electrical terminal as the part of the electrical connection means to which it engages with in use.

In a preferred embodiment at least part of the magnetic means of the electrical means of the second item or further first item part provides a positive electrical terminal and engages with at least part of the positive, electrical terminal of the electrical connection means of the first item or part in use.

Preferably the electrical conductive surface of the magnetic means is substantially linear or flat in form. As such, the substantially linear surface of the electrical means of the second item or further first item part is brought into engagement with at least one of the non-linear surfaces of the electrical connection means of the first item or part in use in order to form electrical connection between the items or parts.

Preferably the electrical means of the at least second item or further first item part further includes engagement means for allowing engagement between the electrical means of the at least second item or further first item part and the electrical connection means of the first item or part. Further preferably at least part of the engagement means forms an electrical terminal of the electrical means of the at least second item or further first item part in use.

In one embodiment the engagement means is in the form of one or more clip members and/or resiliently biased member.

Preferably the one or more clip members are resiliently biased to an engaged position or inwardly protruding position with respect to the electrical connection means of the first item or part in use.

Preferably at least two clips members are provided, and further preferably at least three clip members are provided on the electrical means of the second item or further first item part to engage with the electrical connection means of the first item or part. The at least two clip members are typically located a spaced distance apart and preferably equidistance apart with respect to the magnetic means and/or the electrical means. The clip members typically increase the ease with which the electrical means can be cleaned in use as they do not tend to trap dust or dirt between them due to the relatively large spaces between the clip members.

Preferably at least part of the engagement means of the electrical means of the second item or further first part of the item provides a negative electrical terminal and engages with at least part of the negative electrical terminal of the electrical connection means of the first item or part in use.

In one embodiment the electrical means of the second item or further first item part includes a channel or recess and the electrical terminals are provided at the end, base end or closed end of the channel or recess opposite to an open end thereof.

In a preferred embodiment the engagement means of the electrical means of the second item or further first item part protrudes outwardly from a free end of the electrical means and is/arc moved into engagement with the annular member of the electrical connection means of the first item or part in use.

Preferably the parts of the engagement means and the magnetic means forming the electrical terminals of the second item or further first item part are formed from electrically conductive material, such as metal, a metal alloy and/or the like.

In one embodiment one of the first and second items is a battery or electrical connection means associated with a battery and the other of the first and second items is a battery charger or electrical connection means associated with a battery charger.

The electrical connection means and/or electrical means of the first and/or second items can include any number of electrical terminals therewith. For example, the electrical connection means could include two or more annular members to form two or more electrical terminals, one or more or all being positive and/or negative terminals. The electrical means of the second item or further first item part could include a plurality of engagement means forming two or more electrical terminals, one or more or all positive and/or negative terminals.

In a preferred embodiment, the provision of the magnetic terminal of the second item or further first item part pulls the corresponding terminal of the first item or part into engagement with the same in use. Preferably this forms the positive terminal engagement. The spring or resilient biased terminal clips on the second item or first further item part pull the electrical terminals of the first item or part into position, thereby placing the electrical connection means of the first item or part substantially centrally of the electrical means of the second item or further first item part.

According to a second aspect of the present invention there is provided electrical connection apparatus, said electrical connection apparatus including electrical connection means provided on or associated with a first item or part in use and electrical means provided on or associated with a second item or further first item part in use.

According to further independent aspects of the present invention there is provided a first item or part with electrical connection means; and a second item or further first item part with electrical means.

According to further independent aspects of the present invention there is provided a method of using electrical connection means; and a method of using electrical means.

According to one aspect of the present invention there is provided a method of using electrical connection apparatus, electrical connection apparatus including electrical connection means for a first item or part and electrical means for a second item or further first item part, said electrical connection means including first and at least second non-linear surfaces or parts providing one or more electrical terminals for the electrical connection means, said method including the step of bringing said non-linear surfaces of the electrical connection means of the first item or parts into engagement with one or more electrical terminals of the electrical means of the second item or further first item part.

An embodiment of the present invention will now be described with reference to the accompanying figures, wherein:

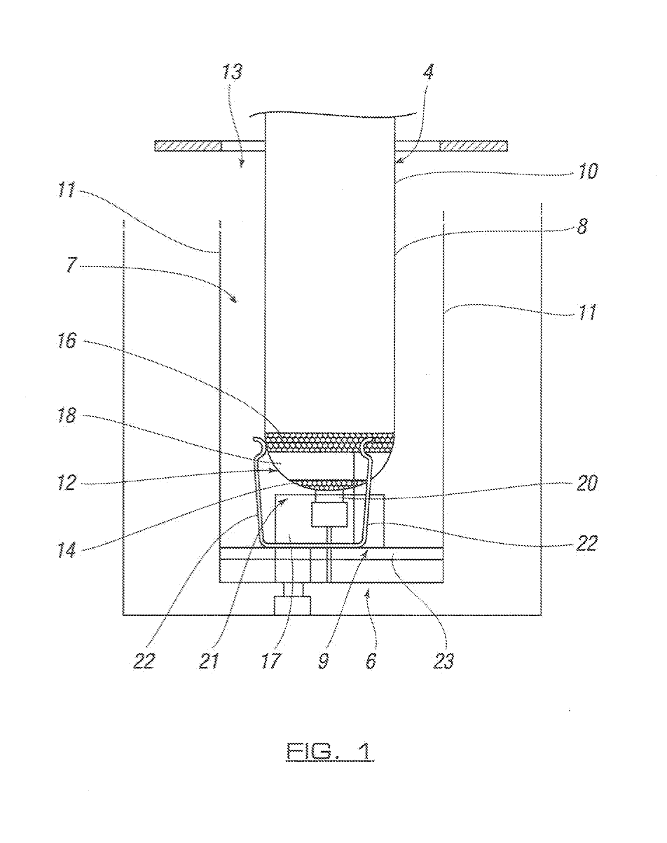

FIG. 1 is a side view of the electrical connection apparatus according to an embodiment of the present invention.

Referring to FIG. 1, there is illustrated electrical connection apparatus 2 between a first item in the form of a battery 4 and a second item in the form of a battery charger 6.

The electrical connection means of the battery 4 includes an elongate pin member 8 having a first end 10 attached to the battery and a second free end 12. In accordance with the present invention, the electrical connection means includes at least two non-linear surfaces; a first substantially domed shaped surface 14 provided at free end 12 forming the positive electrical terminal of the battery 4 and an annular member 16, the external surface of which provides the second non-linear surface forming the negative electrical terminal of the battery 4. Dome surface 14 and annular member 16 are substantially concentrically arranged. Annular negative terminal 16 is separated from positive dome terminal 14 by annular insulation member 18. The insulation member 18 is formed from non-electrical conductive material and is adjacent to and in abutting relationship with the electrically conductive material of positive terminal 14 and negative terminal 16. Thus, negative terminal 16 is a spaced distance from free end 12 and positive terminal 14.

The electrical means of the battery charger 6 are provided in a recess 7 having a base 9, side walls 11 and an open end 13. The electrical means includes a positive electrical terminal 20, which is also magnetic, provided adjacent base 9 and at free end 21 of a docking location. The polarity of magnetic terminal 20 is the opposite to the polarity of dome terminal 14 on the battery such that the terminals are magnetically attracted to each other in use. The positive electrical terminal 20 typically has a substantially flat or linear surface for engagement with the non-linear surface of terminal 14 in use. Three spring clips 22 protrude outwardly from base 9 of battery charger 6 and are located radially outwardly from magnetic central terminal 20. The three clips 22 are also located equidistance apart from each other. The three spring clips 22 form the negative electrical terminal of the battery charger 6. The positive and negative terminals 20, 22 of the battery charger are typically connected to a printed circuit board 23 to control electrical charge supplied to the terminals for charging battery 4 in use. Insulation means 17 are provided between the clip terminals 22 and the magnetic terminal 20.

In use, as the battery 4 is brought into engagement with battery charger 6, the magnetic terminal 20 is attracted to the dome terminal 14, thereby forming a positive engaging force between terminals 20 and 14 and making the positive electrical terminals engage. The spring clips 22 engage with the sides of elongate pin member 8 and centre pin member 8, and therefore dome terminal 14 with magnetic terminal 20. The spring clips 22 engage against annular member 16 to form engagement between the negative electrical terminals. The clips 22 retain member 8 of the battery in engagement with the battery charger.

The spring clips are resiliently biased to an engaged or inwardly protruding position (i.e. biased towards member 8 located between the clips when engaged therewith) with the battery in use to secure the battery in place on the battery charger. The spring clips are typically elongate members with a convex portion or non-linear surface at the free end of the clip engaging against the non-linear surface of annular member 16. The longitudinal axes of the clips 22 are substantially parallel to the longitudinal axis of the elongate member 8 when engaged therewith.

The advantage of the electrical connection apparatus of the present invention is that the electrical connection means of the battery can be brought into engagement with the electrical connection means of the battery charger in any orientation. The magnet of the positive terminal of the battery charger maintains a positive engaging force with the positive dome shaped terminal of the battery. The battery cannot be short circuited by way of contact with a flat conducting surface of the positive terminal of the battery charger.

1. Electrical connection means for a first item for allowing electrical connection between the first item or a part of the first item with electrical means of at least a second item or further part of the first item in use, said electrical connection means comprising: first and at least second non-linear surfaces or parts providing one or more electrical terminals for the electrical connection means.

2. Electrical connection means according to claim 1 wherein the first non-linear surface or part acts as a first electrical terminal and the at least second non-linear surface or part acts as a second electrical terminal, or both the first and at least second non-linear surfaces or parts act as a first or second electrical terminal.

3. Electrical connection means according to claim 1 wherein the first and at least second non-linear surfaces or parts are formed from or include electrically conductive material, and electrical insulation means or non-conductive material is/are provided between said first and at least second non-linear surfaces to insulate the non-linear surfaces or parts from each other.

4. Electrical connection means according to claim 3 wherein the electrical insulation means or non-conductive material is also in the form of one or more non-linear surfaces.

5. Electrical connection means according to claim 1 wherein the first and/or at least second non-linear surfaces and/or electrical insulation means or non-conductive material include any or any combination of one or more substantially dome shape surfaces, curved surfaces, partially or wholly spherical surfaces, concave surfaces, convex surfaces, an arc of a circle or substantially annular members.

6. Electrical connection means according to claim 1 wherein the first non-linear surface is substantially dome shaped, the at least second non-linear surface is substantially annular in shape and/or the electrical insulation means or non-conductive material is substantially annular in shape, the one or more substantially dome shaped surfaces and one or more of the substantially annular surfaces are concentrically arranged.

7. Electrical connection means according to claim 1 wherein the electrical connection means is in the form of a blade, arm member or pin; an electrical terminal, positive electrical terminal and/or substantially dome shaped surface associated with or provided at a free end of the blade, arm member or pin; and an electrical terminal, negative electrical terminal and/or substantially annular surface provided on the blade, arm member or pin a spaced distance from the free end thereof.

8. Electrical means provided on or associated with the at least second item or further first item part for electrical connection with the first item or part according to claim 1, wherein the electrical means include magnetic means or one or more magnetic members for magnetic attraction with at least one of the electrical terminals of the electrical connection means of the first item or first item part.

9. Electrical means according to claim 8 wherein at least part of the magnetic means provides an electrical terminal for the at least second item or further first item part, the electrical terminal being of the same positive or negative electrical terminal type as the electrical terminal with which it engages on the first item or first item part in use.

10. Electrical means according to claim 8 wherein the magnetic means or electrical conductive material of the magnetic means is substantially linear or flat in form.

11. Electrical means according to claim 8 wherein the electrical means further includes engagement means in the form of one or more clip members and/or resilient biasing means for allowing engagement of the electrical means of the second item or further first item part with the electrical connection means of the first item or part in use.

12. Electrical means according to claim 11 wherein the engagement means provides a negative electrical terminal for engagement with at least part of the negative electrical terminal of the electrical connection means of the first item or part in use.

13. Electrical means according to claim 8 wherein the electrical means of the second item or further first item part includes a channel or recess and one or more electrical terminals are provided at an end, base end or closed end of the channel or recess, opposite to an open end of said channel or recess.

14. Electrical connection apparatus, said electrical connection apparatus comprising: electrical connection means for a first item or part according to claim 1 and electrical means for a second item or further first item part according to claim 8.

15. A method of using electrical connection apparatus, electrical connection apparatus including electrical connection means for a first item or part and electrical means for a second item or further first item part, said electrical connection means including first and at least second non-linear surfaces or parts providing one or more electrical terminals for the electrical connection means, said method comprising: the step of bringing said non-linear surfaces of the electrical connection means of the first item or parts into engagement with one or more electrical terminals of the electrical means of the second item or further first item part.
